(19) United States
(12) Patent Application Publication
(10) Pub. No.: US 2018/0225633 A1
(43) Pub. Date: Aug. 9, 2018

(54) JOB SEARCH BASED ON RELATIONSHIP OF MEMBER TO COMPANY POSTING JOB

(71) Applicant: LinkedIn Corporation, Sunnyvale, CA (US)

(72) Inventors: KRISHNARAM KENTHAPADI, Sunnyvale, CA (US); Kaushik Rangadurai, Sunnyvale, CA (US)

(21) Appl. No.: 15/424,082

(22) Filed: Feb. 3, 2017

(51) Int. Cl. G06Q 10/10; G06N 99/00; G06F 17/11; G06F 17/30; H04L 29/08

(52) U.S. Cl. CPC G06Q 10/1053; G06N 99/005; G06Q 50/01; G06F 17/30867; H04L 67/306; G06F 17/11

(57) ABSTRACT

Methods, systems, and computer programs are presented for searching jobs for a social network member based on member interaction with the companies offering the jobs. One method includes an operation for identifying jobs based on a search for jobs for a member of a social network, each job being offered by a respective company. For each job, a job affinity score is determined based on a comparison of data of the job and a profile of the member. For each company, a company affinity score, indicating a level of interaction between the member and the company, is determined. Further, the method includes operations for ranking the jobs based on the company affinity score of the company offering the job and the job affinity score, and for causing presentation of a group including one or more of the ranked jobs in a user interface of the member based on the ranking.

### TECHNICAL FIELD

The subject matter disclosed herein generally relates to methods, systems, and programs for searching a database of job offerings to obtain jobs for a member of a social network based on job data and member profile data.

### BACKGROUND

Some social networks provide job postings to their members. The member may perform a job search by entering a job search query, or the social network may suggest jobs that may be of interest to the member. However, current job search methods may miss valuable opportunities for a member because the job search engine limits the search to specific parameters. For example, the job search engine may look for matches of a job in the title to the member's title, but there may be quality jobs that are associated with a different title that would be of interest to the member.

Further, existing job search methods may focus only on the job description or the member's profile, without considering the member's preferences for job searches that go beyond the job description or other information that may help find the best job postings for the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture, according to some example embodiments, including a social networking server.

FIG. 2 is a screenshot of a user interface that includes job recommendations, according to some example embodiments.

FIG. 3 is a screenshot of a user's profile view, according to some example embodiments.

FIG. 4 is a diagram of a user interface, according to some example embodiments, for presenting job postings to a member of a social network.

FIG. 5 is a detail of a group area in the user interface of FIG. 4, according to some example embodiments.

FIG. 6 illustrates data structures for storing job and member information, according to some example embodiments.

FIGS. 7A-7B illustrate the scoring of a job for a member, according to some example embodiments.

FIG. 8 illustrates the training and use of a machine-learning program, according to some example embodiments.

FIG. 9 illustrates the relationship between a member and companies offering jobs, according to some example embodiments.

FIG. 10 illustrates the calculation of the company affinity score, according to some example embodiments.

FIG. 11 illustrates a method for selecting jobs for presentation within a group, according to some example embodiments.

FIG. 12 illustrates another method for selecting jobs for presentation within a group, according to some example embodiments.

FIG. 13 illustrates a social networking server for implementing example embodiments.

FIG. 14 is a flowchart of a method, according to some example embodiments, for searching job postings for a member of a social network based on transitions of members in the social network from educational institutions to companies.

FIG. 15 is a block diagram illustrating an example of a software architecture that may be installed on a machine, according to some example embodiments.

FIG. 16 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to searching job postings for a member of a social network based on the interactions of the member with the companies offering the jobs. Examples merely typify possible variations. Unless explicitly stated otherwise, components and functions are optional and may be combined or subdivided, and operations may vary in sequence or be combined or subdivided. in the following description, for purposes of explanation, numerous specific details are set forth to provide a thorough understanding of example embodiments. It will be evident to one skilled in the art, however, that the present subject matter may be practiced without these specific details.

One of the goals of the present embodiments is to personalize and redefine how job postings are searched and presented to job seekers. Another goal is to better explain why particular jobs are recommended to the job seekers. The presented embodiments provide both active and passive job seekers with valuable job recommendation insights, thereby greatly improving their ability to find and assess jobs that meet their needs.

Instead of providing a single job recommendation list for a member, embodiments presented herein define a plurality of groups, and the job recommendations are presented within the groups. Each group provides an indication of a feature that is important to the member for selecting from the group, such as how related the job searcher is to a company offering a job, how many people have transitioned from the university of the member to the company of the job, who would be a virtual team for the member if the member joined the company, and so forth.

Embodiments presented herein analyze data regarding the relationship between a member and companies offering jobs. If the system determines a close relationship between the member and a company, the jobs offered by this company will be presented with prominence to the member, given the interest of the member in the company. The close relationship between the member and the company is determined by assessing multiple factors, also referred to herein as signals, such as the member following the company in a social network, the member looking at jobs offered by the company, the member performing research on the company, a large number of connections between the member and employees of the company, and so forth.

One general aspect includes a method including an operation for identifying, by one or more processors, a plurality of jobs based on a search for jobs for a member of a social network. Each job is offered by a respective company. The method also includes determining for each job, by the one or more processors, a job affinity score based on a comparison of data of the job and a profile of the member. The method further includes determining for each company, by the one or more processors, a company affinity score indicating a level of interaction between the member and the company. The method also includes operations for ranking, by the one or more processors, the jobs based on the company affinity score of the company offering the job and the job affinity score, and for causing, by the one or more processors, presentation of a group including one or more of the ranked jobs in a user interface of the member based on the ranking.

One general aspect includes a system including a memory with instructions and one or more computer processors. The instructions, when executed by the one or more computer processors, cause the one or more computer processors to perform operations including identifying, by one or more processors, a plurality of jobs based on a search for jobs for a member of a social network. Each job is offered by a respective company. The operations also include determining for each job, by the one or more processors, a job affinity score based on a comparison of data of the job and a profile of the member. The operations further include determining for each company, by the one or more processors, a company affinity score indicating a level of interaction between the member and the company. The operations also include ranking, by the one or more processors, the jobs based on the company affinity score of the company offering the job and the job affinity score, and causing, by the one or more processors, presentation of a group including one or more of the ranked jobs in a user interface of the member based on the ranking.

One general aspect includes a non-transitory machine-readable storage medium including instructions that, when executed by a machine, cause the machine to perform operations including identifying, by one or more processors, a plurality of jobs based on a search for jobs for a member of a social network. Each job is offered by a respective company. The operations also include determining for each job, by the one or more processors, a job affinity score based on a comparison of data of the job and a profile of the member. The operations further include determining for each company, by the one or more processors, a company affinity score indicating a level of interaction between the member and the company. The operations also include ranking, by the one or more processors, the jobs based on the company affinity score of the company offering the job and the job affinity score, and causing, by the one or more processors, presentation of a group including one or more of the ranked jobs in a user interface of the member based on the ranking.

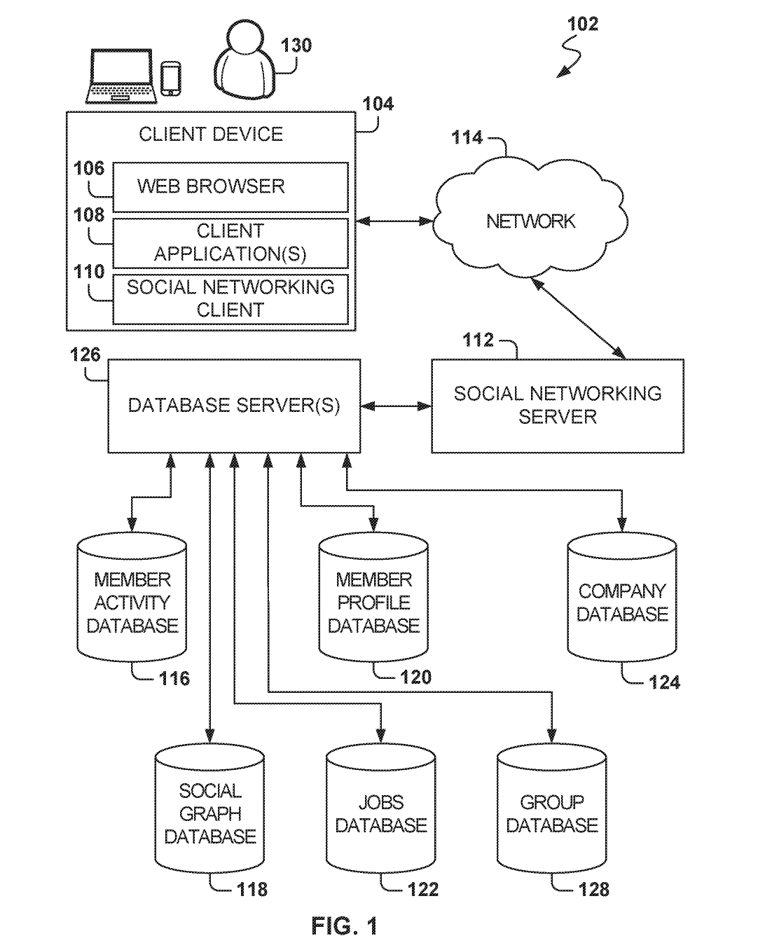

FIG. 1 is a block diagram illustrating a network architecture 102, according to some example embodiments, including a social networking server 112 The social networking server 112 provides server-side functionality via a network 114 (e.g., the Internet or a wide area network (WAN)) to one or more client devices 104. FIG. 1 illustrates, for example, a web browser 106 (e.g., the Internet Explorer® browser developed by Microsoft® Corporation), client application(s) 108, and a social networking client 110 executing on a client device 104. The social networking server 112 is further communicatively coupled with one or more database servers 126 that provide access to one or more databases 116-128.

The client device 104 may comprise, but is not limited to, a mobile phone, a desktop computer, a laptop, a portable digital assistant (PDA), a smart phone, a tablet, a book reader, a netbook, a multi-processor system, a microprocessor-based or programmable consumer electronic system, or any other communication device that a user 130 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 130 may be a person, a machine, or another means of interacting with the client device 104. In various embodiments, the user 130 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi® network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 130, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-128. In one example embodiment, the social networking server 112 is communicatively coupled to a member activity database 116, a social graph database 118, a member profile database 120, a jobs database 122, a group database 128, and a company database 124. Each of the databases 116-128 may be implemented as one or more types of databases including, but not limited to, a hierarchical database, a relational database, an object-oriented database, one or more flat files, or combinations thereof.

The member profile database 12.0 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry (also referred to herein simply as industry), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member, but some companies may not be members of the social network, although some of the employees of the company may be members of the social network. The company database 124 includes company information, such as name, industry, contact information, website, address, location, geographic scope, and the like.

As members interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content from outside of the social networking service (e.g., an article provided by an entity other than the social networking server 112), updating a current status, posting content for other members to view and comment on, job suggestions for the members, job-post searches, and other such interactions. In one embodiment, records of these interactions are stored in the member activity database 116, which associates interactions made by a member with his or her member profile stored in the member profile database 120. In one example embodiment, the member activity database 116 includes the posts created by the members of the social networking service for presentation on member feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

The group database 128 includes group-related information. As used herein, a group includes jobs that are selected based on a group characteristic that provides an indication of why the jobs in the group are selected for presentation to the member. Examples of group characteristics include relationships between an educational institution of the member and the employees of a company who also attended the educational institution, virtual teams in the company with profiles similar to the member's profile, cultural fit of the member within the company, social connections of the member who work at the company, and the like.

Members of the social networking service may establish connections with one or more members of the social networking service. The connections may be defined as a social graph, where the member is represented by a vertex in the social graph and the edges identify connections between vertices. Members are said to be first-degree connections where a single edge connects the vertices representing the members; otherwise, members are said to have connections of the n^{th} degree, where n is defined as the number of edges separating two vertices. In one embodiment, the social graph maintained by the social networking server 112 is stored in the social graph database 118.

In one embodiment, the social networking server 112 communicates with the various databases 116-128 through the one or more database server(s) 126. In this regard, the database server(s) 126 provide one or more interfaces and/or services for providing content to, modifying content in, removing content from, or otherwise interacting with the databases 116-128. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates directly with the databases 116-128 and includes a database client, engine, and/or module, for providing data to, modifying data stored within, and/or retrieving data from the one or more databases 116-128.

While the database server(s) 126 are illustrated as a single block, one of ordinary skill in the art will recognize that the database server(s) 126 may include one or more such servers. For example, the database server(s) 126 may include, but are not limited to, a Microsoft® Exchange Server, a Microsoft') Sharepoint® Server, a Lightweight Directory Access Protocol (LDAP) server, a MySQL, database server, or any other server configured to provide access to one or more of the databases 116-128, or combinations thereof. Accordingly, and in one embodiment, the database server(s) 126 implemented by the social networking service are further configured to communicate with the social networking server 112.

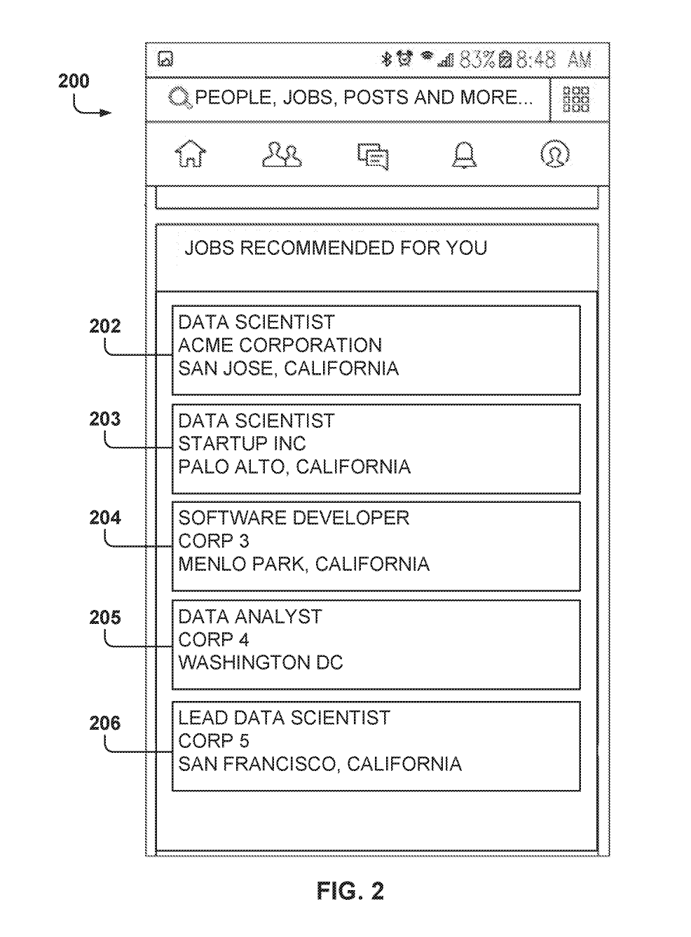

FIG. 2 is a screenshot of a user interface 200 that includes recommendations for jobs 202-206, according to some example embodiments. In one example embodiment, the social network user interface provides job recommendations, which are job postings that match the job interests of the user that are presented without a specific job search request from the user (e.g., job suggestions)

In another example embodiment, a job search interface is provided for entering job searches, and the resulting job matches are presented to the user in the user interface 200.

As the user scrolls down the user interface 200, more job recommendations are presented to the user. In some example embodiments, the job recommendations are prioritized to present jobs in an estimated order of interest to the user,

The user interface 200 presents a “flat” list of job recommendations as a single list. Other embodiments presented below utilize a “segmented” list of job recommendations where each segment is a group that is associated with a related reason indicating why these jobs are being recommended within the group.

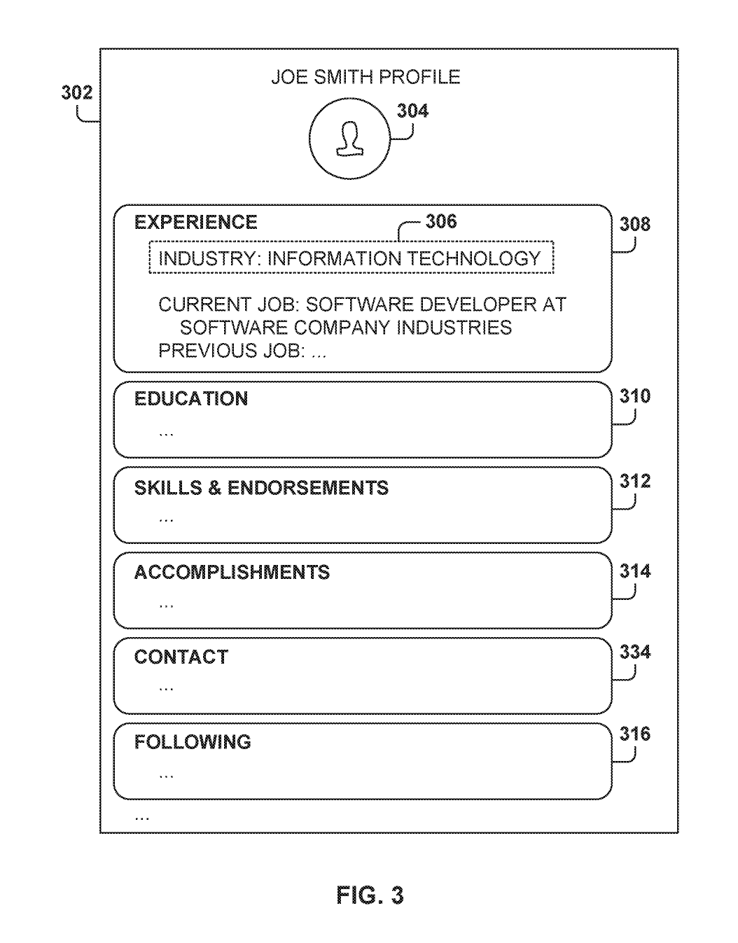

FIG. 3 is a screenshot of a user's profile view, according to some example embodiments. Each user in the social network has a member profile 302, which includes information about the user. The member profile 302 is configurable by the user and also includes information based on the user's activity in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the member's account is associated with the number of endorsements received for each skill from other members.

The experience 308 information includes information related to the professional experience of the user. In one example embodiment, the experience 308 information includes an industry 306, which identifies the industry in which the user works. In one example embodiment, the user is given an option to select an industry from a plurality of industries when entering this value in the member profile 302. The experience 308 information area may also include information about the current job and previous jobs held by the user.

The education 310 information includes information about the educational background of the user, including the educational institutions attended by the user, the degrees obtained, and the field of study of the degrees. For example, a member may list that the member attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, and the like.

The skills and endorsements 312 information includes information about professional skills that the user has identified as having been acquired by the user and endorsements entered by other users of the social network supporting the skills of the user. The accomplishments 314 area includes accomplishments entered by the user, and the contact information 334 includes contact information for the user, such as an email address and phone number. The following 316 area includes the names of entities in the social network being followed by the user.

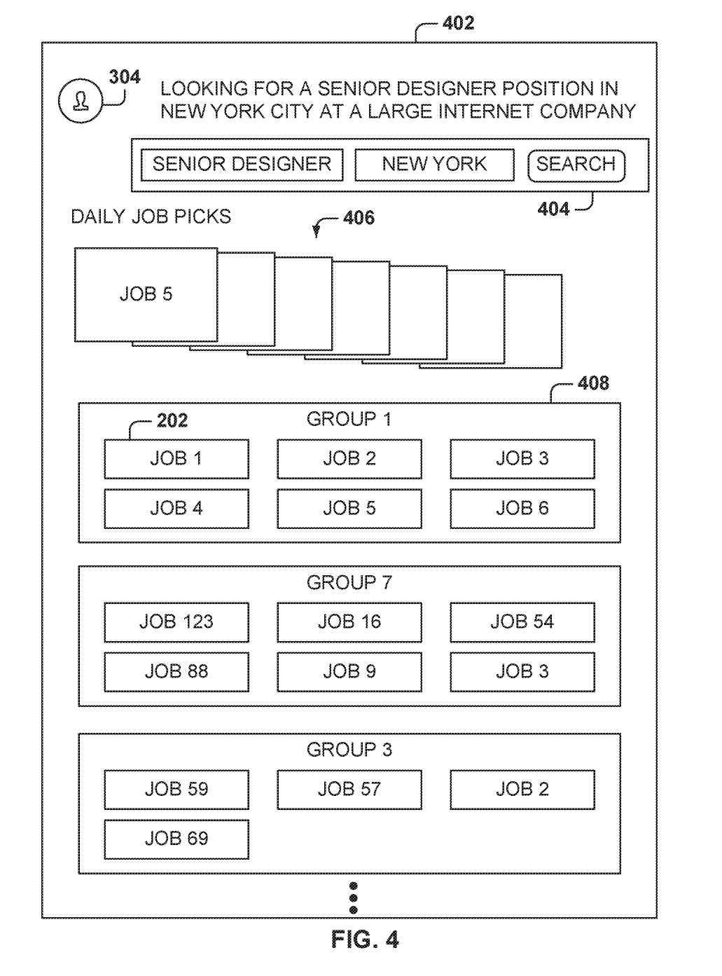

FIG. 4 is a diagram of a user interface 402, according to some example embodiments, for presenting job postings to a member of the social network. The user interface 402 includes the profile picture 304 of the member, a search section 404, a daily jobs section 406, and one or more group areas 408. In some example embodiments, a message next to the profile picture 304 indicates the goal of the search, e.g., “Looking for a senior designer position in New York City at a large Internet company.”

The search section 404, in some example embodiments, includes two boxes for entering search parameters: a keyword input box for entering any type of keywords for the search (e.g., job title, company name, job description, skill, etc.), and a geographic area input box for entering a geographic area for the search (e.g., New York). This allows members to execute searches based on keyword and location. In some embodiments, the geographic area input box includes one or more of city, state, ZIP Code, or any combination thereof.

In some example embodiments, the search boxes may be prefilled with the user's title and location if no search has been entered yet. Clicking the search button causes the search of jobs based on the keyword inputs and location. It is to be noted that the inputs are optional, and only one search input may be entered at a time or both search boxes maybe filled in.

The daily jobs section 406 includes information about one or more jobs selected for the user, based on one or more parameters, such as member profile data, search history, job match to the member, recentness of the job, whether the user is following the job, and the like.

Each group area 408 includes one or more jobs 202 for presentation in the user interface 402. In one example embodiment, the group area 408 includes one to six jobs with an option to scroll the group area 408 to present additional jobs, if available.

Each group area 408 provides an indication of why the member is being presented with those jobs, which identifies the characteristic of the group. There could be several types of reasons related to the connection of the user to the job, the affinity of the member to the group, the affinity of the member to a company, the desirability of the job, or the time deadline of the job (e.g, urgency). The reasons related to the connection of the user to the job may include relationships between the job and the social connections of the member (e.g., “Your connections can refer you to this set of jobs”), a quality of a fit between the job and the user characteristics (e.g., “This is a job from a company that hires from your school”), a quality of a match between the member's talent and the job (e.g., “You would be in the top 90% of all applicants), and so forth.

Further, the group characteristics may be implicit (e.g., “These jobs are recommended based on your browsing history”) or explicit (e.g., “These are jobs from companies you follow,” “These jobs are for companies you may be interested in”). The desirability reasons may include popularity of the job in the member's area (e.g., most-viewed by other members or most applications received), jobs from in-demand start-ups in the member's area, and popularity of the job among people with the same title as the member. Further yet, the time-urgency reasons may include “Be the first to apply to these jobs,” or “These jobs will be expiring soon.”

It is to be noted that the embodiments illustrated in FIG. 4 are examples and do not describe every possible embodiment. Other embodiments may utilize different layouts or groups, present fewer or more jobs, present fewer or more groups, etc. The embodiments illustrated in FIG. 4 should therefore not be interpreted to be exclusive or limiting, but rather illustrative.

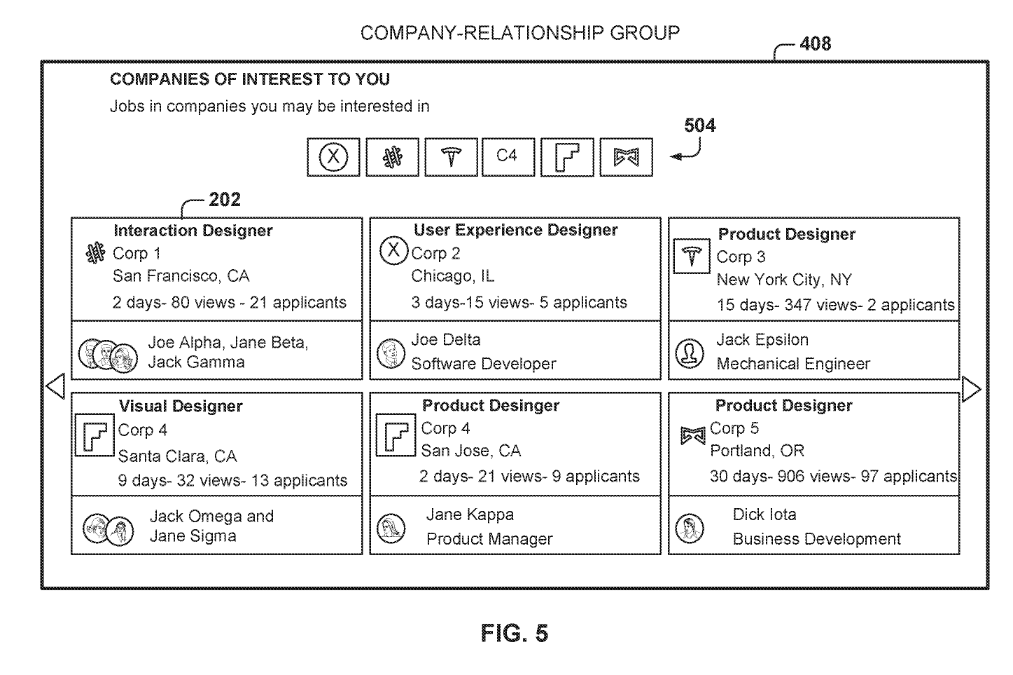

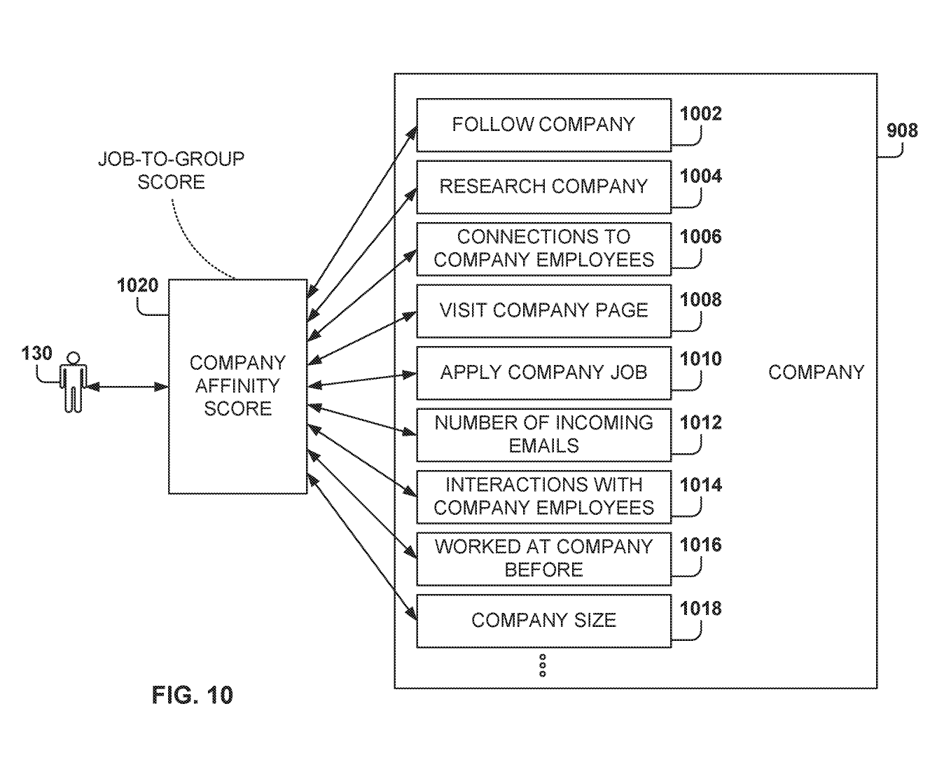

FIG. 5 is a detail of the group area 408 in the user interface, according to some example embodiments. In one example embodiment, the group area 408 is for a group referred to as a company-relationship group, which presents jobs offered by companies in which the member is interested. In some example embodiments, the relationship between the member and a company is quantified as a company affinity score that indicates a level of interaction between the member and the company. The higher the interest of the member in the company, the higher the company affinity score is; that is, when the member is very interested in a particular company, the company affinity score will be high, while if the member is not interested in a given company, the company affinity score will be low. In some example embodiments, the company affinity score is a real number between zero (no company affinity) and one (high level of interest by the member in the company). In other example embodiments, different score scales may be used, such as from 0 to 100, A to E, and so forth. More details are provided below with reference to FIG. 10 regarding the calculation of the company affinity score.

In one example embodiment, the education-company group area 408 includes a list of companies 504 included in the company-relationship group, and the list may be shown as a plurality of icons or may include a list of company names (not shown). In addition, the education-company group area 408 includes a plurality of jobs 202 relevant to this group. If additional jobs related to the group are available for presentation, scroll selectors are available to view the additional jobs.

Each job 202 includes information about the job and information about the colleagues of the member who work at that company. In some example embodiments, the job 202 description includes the job title, logo and name of the company, job location, and job statistics, such as the number of days since the job was first posted, the number of members who have viewed the job, and the number of applications for the job received in the social network. In addition, any combination of profile pictures, member names, and member titles may be included to identify the connections of the member to the job 202 via the member's colleagues.

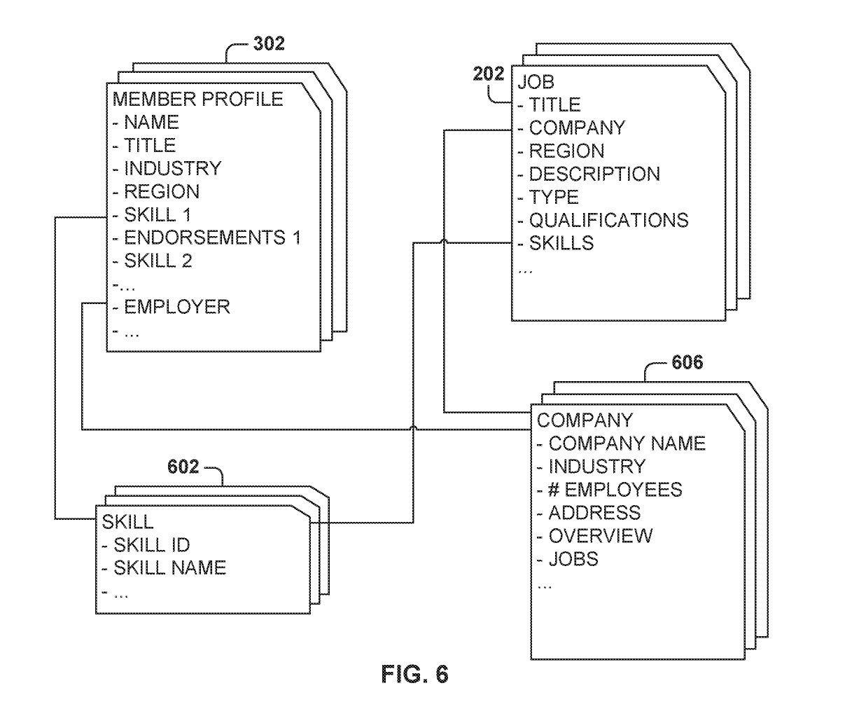

FIG. 6 illustrates data structures for storing job and member information, according to some example embodiments. The member profile 302, as discussed above, includes member information, such as name, title (e.g., job title), industry (e.g., legal services), geographic region, employer, skills and endorsements, and so forth. In some example embodiments, the member profile 302 also includes job-related data, such as jobs previously applied to, or jobs already suggested to the member (and how many times each job has been suggested to the member). Within the member profile 302, the skill information is linked to skill data 602 and the employer information is linked to company data 606.

In one example embodiment, the company data 606 includes company information, such as company name, industry associated with the company, number of employees at the company, address of the company, overview description of the company, job postings associated with the company, and the like

The skill data 602 is a table for storing the different skills identified in the social network. In one example embodiment, the skill data 602 includes a skill identifier (ID) (e.g., a numerical value or a text string) and a name for the skill. The skill identifier may be linked to the member profile 302 and job 202 data.

In one example embodiment, the job 202 data includes data for jobs posted by companies in the social network. The job 202 data includes one or more of a title associated with the job (e.g., Software Developer), a company that posted the job, a geographic region where the job is located, a description of the job, a type of the job, qualifications required for the job, and one or more skills. The job 202 data may be linked to the company data 606 and the skill data 602.

It is to be noted that the embodiments illustrated in FIG. 6 are examples and do not describe every possible embodiment. Other embodiments may utilize different data structures or fewer data structures, combine the information from two data structures into one, have additional or fewer links among the data structures, and the like. The embodiments illustrated in FIG. 6 should therefore not be interpreted to be exclusive or limiting, but rather illustrative.

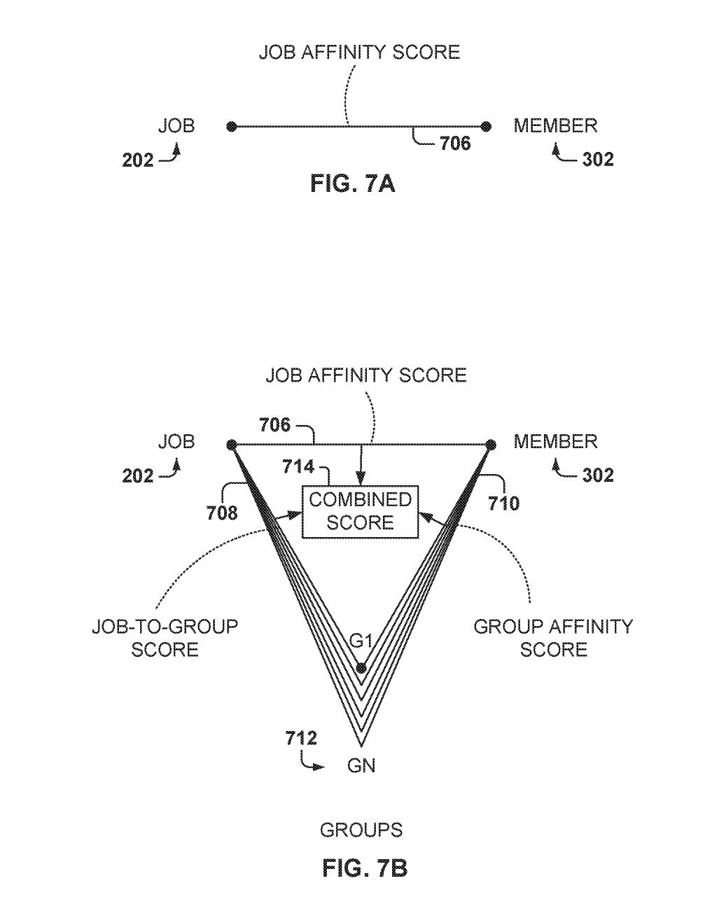

FIGS. 7A-7B illustrate the scoring of a job for a member, according to some example embodiments. FIG. 7A illustrates the scoring, also referred to herein as ranking, of a job 202 for a member associated with a member profile 302 based on a job affinity score 706.

The job affinity score 706, between a job and a member, is a value that measures how well the job matches the interest of the member in finding the job. A so called “dream job” for a member would be the perfect job for the member and would have a high, or even maximum, value, while a job that the member is not interested in at all (e.g., in a different professional industry) would have a low job affinity score 706. In some example embodiments, the job affinity score 706 is a value between zero and one, or a value between zero and 100, although other ranges are possible.

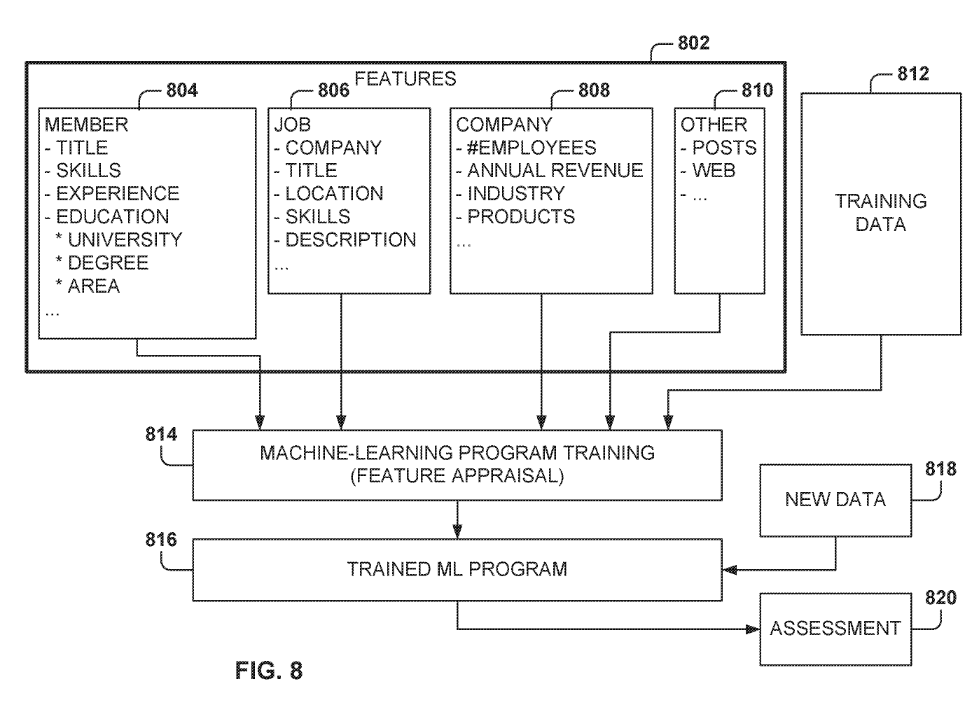

in some example embodiments, a machine-learning program is used to calculate the job affinity scores for the jobs available to the member. The machine-learning program is trained with existing data in the social network, and the machine-learning program is then used to evaluate jobs based on the features used by the machine-learning program. In some example embodiments, the features include any combination of job data (e.g., job title, job description, company, geographic location, etc.), member profile data, member search history, employment of social connections of the member, job popularity in the social network, number of days the job has been posted, company reputation, company size, company age, profit vs. nonprofit company, and pay scale. More details are provided below with reference to FIG. 8 regarding the training and use of the machine-learning program.

FIG. 7B illustrates the scoring of a job 202 for a member associated with the member profile 302, according to some example embodiments, based on three parameters: the job affinity score 706, a job-to-group score 708, and a group affinity score 710. Broadly speaking, the job affinity score 706 indicates how relevant the job 202 is to the member, the job-to-group score 708 indicates how relevant the job 202 is to a group 712, and the group affinity score 710 indicates how relevant the group 712 is to the member.

The group affinity score 710 indicates how relevant the group 712 is to the member, where a high affinity score indicates that the group 712 is very relevant to the member and should be presented in the user interface, while a low affinity score indicates that the group 712. is not relevant to the member and may be omitted from presentation in the user interface.

The group affinity score 710 is used, in some example embodiments, to determine which groups 712 are presented in the user interface, as discussed above, and the group affinity score 710 is also used to order the groups 712 when presenting them in the user interface, such that the groups 712 may be presented in the order of their respective group affinity scores 710. It is to be noted that if there is not enough “liquidity” of jobs for a group 712 (e.g., there are not enough jobs for presentation in the group 712), the group 712 may be omitted from the user interface or presented with lower priority, even if the group affinity score 710 is high.

In some example embodiments, a machine-learning program is utilized for calculating the group affinity score 710. The machine-learning program is trained with member data, including interactions of users with the different groups 712. The data for the particular member is then utilized by the machine-learning program to determine the group affinity score 710 for the member with respect to a particular group 712. The features utilized by the machine-learning program include the history of interaction of the member with jobs from the group 712, click data for the member (e.g., a click rate based on how many times the member has interacted with the group 712), member interactions with other members who have a relationship to the group 712, and the like. For example, one feature may include an attribute that indicates if the member is a student, and if the member is a student, features such as social connections or education-related attributes will be important to determine which groups are of interest to the student. On the other hand, a member who has been out of school for 20 years or more may not be as interested in education-related features.

With reference to the company-affinity group, the group affinity score is calculated based on the interactions of the member with different companies. Some of the signals utilized by the machine learning program to calculate the group affinity score 710 may include any of click data (e.g., the member visiting webpages of the company, the member clicking on posts from the company), number of jobs in the company-relationship group checked by the member (e.g., average number of jobs in the group viewed by the member in a month), job affinity scores of the jobs presented in the company-relationship group (e.g., average job affinity score for the top 10 jobs in the group), number of direct connections between the member and employees of the company's posting jobs in the company-relationship group, number of companies with a high company affinity score, and so forth.

Another feature of interest to determine group participation is whether the member has worked in small companies or large companies throughout the member's career. If the member exhibits a pattern of working for large companies, a group that provides jobs for large companies would likely be of more interest to the member than a group that provides jobs in small companies, unless there are other factors, such as recent interaction of the member with jobs from small companies.

The job-to-group score 708 between a job 202 and a group 712 indicates the job 202's strength within the context of the group 712, where a high job-to-group score 708 indicates that the job 202 is a good candidate for presentation within the group 712 and a low job-to-group score 708 indicates that the job 202 is not a good candidate for presentation within the group 712. In some example embodiments, a predetermined threshold is identified, wherein jobs 202 with a job-to-group score 708 equal to or above the predetermined threshold are included in the group 712 and jobs 202 with a job-to-group score 708 below the predetermined threshold are not included in the group 712.

For example, in a group 712 that presents jobs within the social network of the member, if there is a job 202 for a company within the network of the member, the job-to-group score 708 indicates how strong the member's network is for reaching the company of the job 202.

In some example embodiments, the job affinity score 706, the job-to-group score 708, and the group affinity score 710 are combined to obtain a combined score 714 for the job 202. The scores may be combined utilizing addition, weighted averaging, or other mathematical operations.

FIG. 7B illustrates that, for a given job 202 and member profile 302, there may be a plurality of groups 712 G1, . . . , GN. Embodiments presented herein identify which jobs fit better in which group, and which groups have higher priority for presentation to the member.

In the company-relationship group, the job-to-group score 708 is the company affinity score for the company offering the job. Therefore, the company-relationship group presents jobs of companies that the member is interested in. Since the member is interested in certain companies, there is a high probability that the member would be interested in looking at jobs in the group-relationship group.

FIG. 8 illustrates the training and use of a machine-learning program 816, according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 812 in order to make data-driven predictions or decisions expressed as outputs or assessments 820. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

In general, there are two types of problems in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a job affinity score 706 (e.g., a number from 1 to 100) to qualify each job as a match for the user (e.g., calculating the job affinity score). In other example embodiments, machine learning is also utilized to calculate the group affinity score 710 and the job-to-group score 708. The machine-learning algorithms utilize the training data 812 to find correlations among identified features 802 that affect the outcome.

In one example embodiment, the features 802 may be of different types and may include one or more of member features 804, job features 806, company features 808, and other features 810. The member features 804 may include one or more of the data in the member profile 302, as described in FIG. 6, such as title, skills, experience, education, and so forth. The job features 806 may include any data related to the job 202, and the company features 808 may include any data related to the company. In some example embodiments, additional features in the other features 810 may be included, such as post data, message data, web data, and the like.

With the training data 812 and the identified features 802, the machine-learning tool is trained at operation 814. The machine-learning tool appraises the value of the features 802 as they correlate to the training data 812. The result of the training is the trained machine-learning program 816.

When the machine-learning program 816 is used to perform an assessment, new data 818 is provided as an input to the trained machine-learning program 816, and the machine-learning program 816 generates the assessment 820 as output. For example, when a member performs a job search, a machine-learning program, trained with social network data, uses the member data and job data from the jobs in the database to search for jobs that match the member's profile and activity.

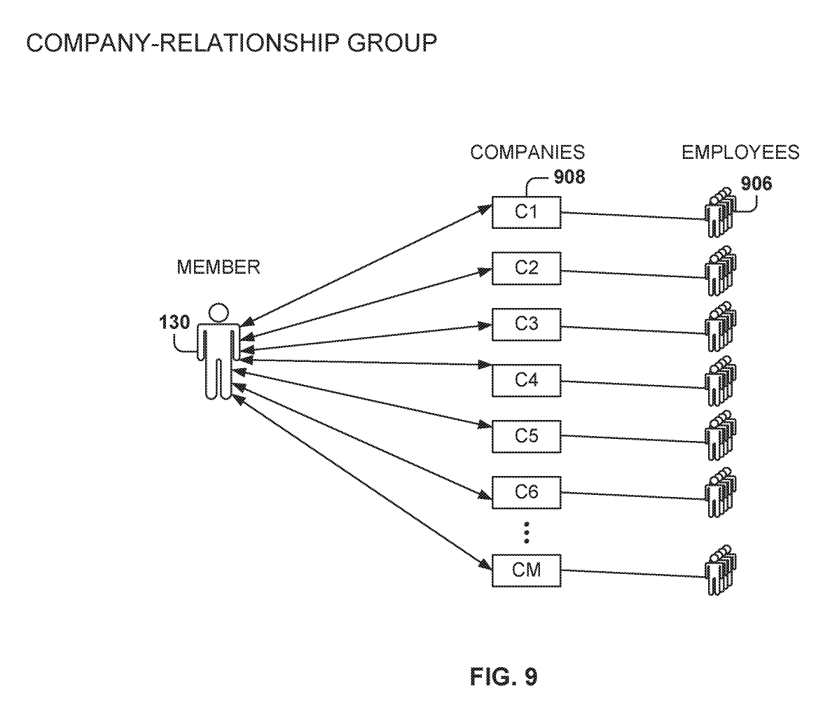

FIG. 9 illustrates the relationship between a member and companies offering jobs, according to some example embodiments. The goal for presenting jobs in the company-relationship group is to find companies that the member is interested in. In one simple approach, the company-relationship group may be filled with jobs from companies that the member is following. However, other embodiments utilize additional signals to denote the extent to which the member is interested in the company.

In some example embodiments, the interactions between the member 130 and the company 908 are examined, as well as the relationships, interactions, and links between the member 130 and employees 906 of the company.

FIG. 10 illustrates the calculation of the company affinity score, according to some example embodiments. In some example embodiments, the profile of the company is built based on the company data and based on data of the company employees. A machine-learning algorithm is used to correlate the member data with the company data in order to calculate the company affinity score 1020. As discussed earlier, the company affinity score 1020 is the job-to-group score for the company-relationship group. The machine-learning program is trained with data from the members of the social network, including the jobs taken by members of the social network, which indicates how the activities of the member correlate to actual job transitions.

The trained machine-learning algorithm then uses member and company data, as well as a plurality of signals that correlate the member activities to company interest. In some example embodiments, the company affinity score 1020 is based on the plurality of signals related to company 908. The plurality of signals include any combination of the member following the company 1002, the member researching the company 1004, the number of connections from the member to company employees 1006, the number of visits from the member to the company webpages 1008, the number of job applications sent to the company by the member 1010 number of incoming emails from the company 1012, interactions between the member and company employees 1014, a flag indicating whether the member worked at the company previously 1016, and a size of the company 1018. Other embodiments may utilize additional signals that correlate the member to the company.

With regards to the signal 1002 defined by the member following the company 908, the system measures if the member has signed up to get notifications from the company, or the number of posts from the company viewed by the member (weighted by the time since the post was posted), number of job recommendations from jobs offered by the company that the member has viewed, and the like. This signal 1002 may be quantified in different bands, such as very high, high, neutral, low, or very low, but numerical values may also be utilized (e.g., in the range from 0 to 1).

With regards to the company-research signal 1004, the system may identify if the user is reading articles posted by the company or company employees, comments on bulletin boards made by the member regarding the company or company employees, active searches initiated by the member that include the company name, and the like.

It is noted that the different signals may also account for the amount of time that the member has been interested in the company. For example, the longer the member has been following the company, the higher the interest in the company will be scored.

The connections to company employees signal 1006 measures the number of direct and indirect connections between the member and company employees, as well as the level of activity between the member and company employees. Therefore, the higher the number of interactions between member and company employees, the higher the company affinity score 1020 is.

The visit company page signal 1008 measures how actively the member visits the company website, and the apply to company jobs signal 1010 measures the amount of applications sent to the company by the member, weighted by the amount of time since each application was sent to the company. Therefore, newer job applications will result in a higher company affinity score 1020 than older job applications (e.g., older than a year).

The number of incoming emails signal 1012 may indicate that the user is very active with company employees, and may include interactions with a company recruiter. A high level of activity means that the member may have been targeting the company for a period of time. Similarly, interactions with company employees signal 1014 measures the interactivity with company employees, such as emails, text messages, visited posts, and the like.

The signal 1016 indicating if the member previously worked at the company may indicate that if the member previously worked at the company, the member may be interested in coming back to the company if the member appears to be tracking company activities. Further, the company size signal 1018 may be utilized to determine the level of interest of the member in the company. For example, if a member has always worked in large companies, the member may be interested in jobs within large companies, or if the member keeps checking jobs offered by small companies, the member may be more interested in small-size companies.

As mentioned above, the trained machine-learning algorithm utilizes the member data, the company data, and the plurality of signals to correlate the member activities to company interest. In some example embodiments, the company affinity score 1020 is calculated by performing a weighted sum for the values of the corresponding signals, where each signal has a respective weight that may be fine tuned by the system in order to prioritize the value of each signal. For example, if the user has applied to jobs with the company, the apply-company-job signal 1010 will be given a higher weight than the signal for company size since the fact that the member has applied to jobs at the company indicate that the size of the company may not be a distinguishing factor.

In some example embodiments, the weights are adjusted by the machine-learning algorithm based on performance data. In some example embodiments, A/B testing may be performed to train the machine-learning algorithm by monitoring member response to jobs posted in the company-relationship group. The system monitors which jobs are selected for view by members, as well as which of the jobs result in job applications. This tracking data is then used to train the machine-learning algorithm in order to assess the impact for each of the signals. Once the machine-learning algorithm is trained, the company affinity score 1020 is calculated based on the training for the jobs available for presentation to the user.

It is noted that the embodiments illustrated in FIG. 10 are examples and do not describe every possible embodiment. Other embodiments may utilize different signals, additional signals, fewer signals, weigh the signals differently, and so forth. The embodiments illustrated in FIG. 10 should therefore not be interpreted to be exclusive or limiting, but rather illustrative.

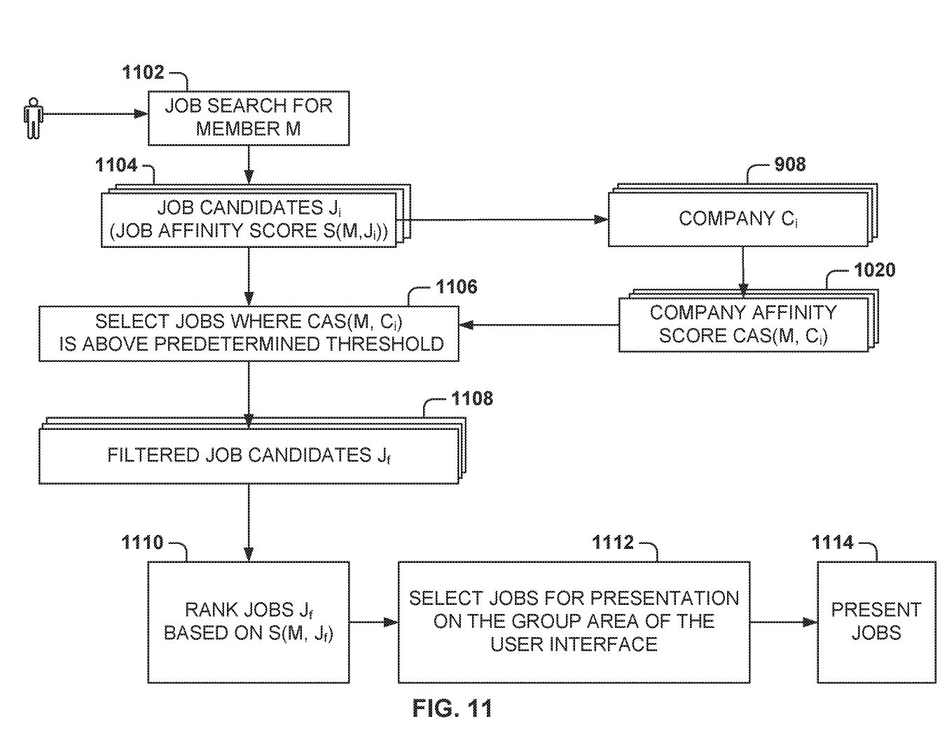

FIG. 11 illustrates a method for selecting jobs for presentation within a group, according to some example embodiments. At operation 1102, a job search is performed for member Al The job search may be initiated by the member by entering a specific job search, or the job search may be initiated by the system in order to suggest jobs for the member without the member having to specifically enter a search.

The result of the job search is a plurality of job candidates Jᵢ 1104, and each job candidate has a job affinity score 706, denoted as S(M, Jᵢ). Each job Jᵢ is offered by a company Cᵢ 908, and each company Cᵢ 908 has a company affinity score 1020 for member Id. denoted as CAS(M, Cᵢ).

At operation 1106, the jobs with low company affinity score are filtered out; i.e., jobs are selected for companies having a company affinity score CAS(M, Cᵢ) above a predetermined threshold. The predetermined threshold may be fined tuned by the system in order to include jobs from companies in which the member is interested. In some example embodiments, the predetermined threshold may be set in order to select the top 10% of jobs, or the top 20% of jobs, according to their company affinity score. In other embodiments, the predetermined threshold is defined by a numerical value (e.g., having a company affinity score above 0.75), but other numerical values and other types of thresholds may also be utilized. The result of the filtering is one or more filtered job candidates J_{f} 1108.

After the jobs are filtered in operation 1108, the method flows to operation 1110 where the filtered jobs J_{f} are ranked (e.g., sorted from higher to lower) based on their job affinity scores S(M, J_{f}).

At operation 1112, jobs are selected for presentation on the group area of the user interface, where the jobs are selected based on the ranking obtained at operation 1110. At operation 1114, the selected jobs are presented on the user interface.

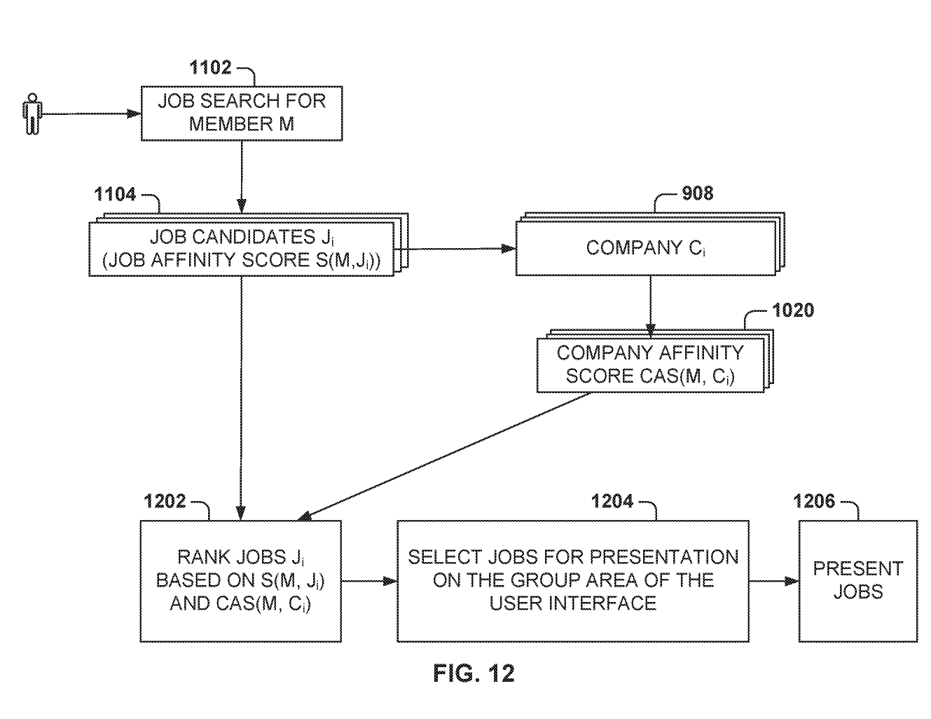

FIG. 12 illustrates another method for selecting jobs for presentation within a group, according to some example embodiments. At operation 1102, a job search is performed for member Al. The result of the job search is a plurality of job candidates Jᵢ 1104, and each job candidate has a job affinity score 706, denoted as S(M, Jᵢ). Each job Jᵢ is offered by a company Cᵢ 908, and each company Cᵢ 908 has a company affinity score 1020 for member M, denoted as CAS(M, Cᵢ).

At operation 1202, the jobs are ranked (e.g., scored) based on the job affinity score S(M, Jᵢ) and the company affinity score CAS(M, Cᵢ) 1020. For example, the scores may be scored by performing a weighted average of the S(M, Jᵢ) and the CAS(M, Cᵢ), or by some other formula, such as the average, a weighted geometric mean, and the like.

At operation 1204, the jobs are selected for presentation on the group area of the user interface, where the jobs are selected based on the ranking obtained at operation 1202. At operation 1206, the selected jobs are presented on the user interface.

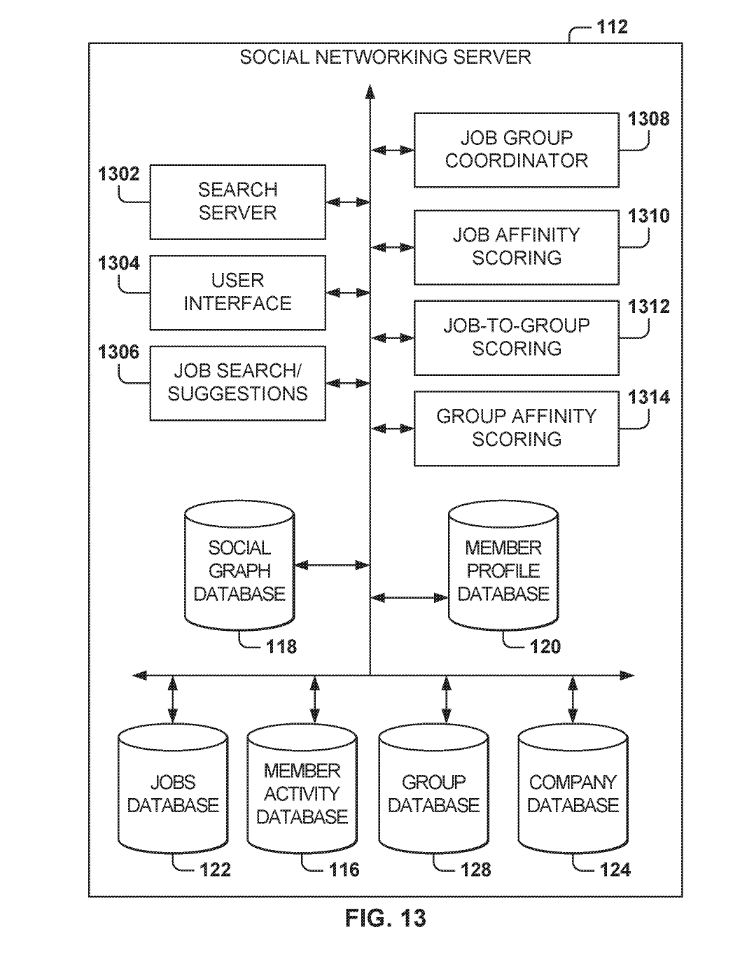

FIG. 13 illustrates a social networking server 112 for implementing example embodiments. In one example embodiment, the social networking server 112 includes a search server 1302, a user interface module 1304, a job search/suggestions engine 1306, a. job group coordinator server 1308, a job affinity scoring server 1310, a job-to-group scoring server 1312, a group affinity scoring server 1314, and a plurality of databases, which include the social graph database 118, the member profile database 120, the jobs database 122, the member activity database 116, the group database 128, and the company database 124.

The search server 1302 performs data searches on the social network, such as searches for members or companies. In some example embodiments, the search server 1302 includes a machine-learning algorithm for performing the searches, which utilizes a plurality of features for selecting and scoring the jobs, The features include, at least, one or more of title, industry, skills, member profile, company profile, job title, job data, region, and salary range. The user interface module 1304 communicates with the client devices 104 to exchange user interface data for presenting the user interface to the user. The job search/suggestions engine 1306 performs job searches based on a search query (e.g., using one or more keywords and a geographic location as illustrated in FIG. 4) or based on a member profile in order to offer job suggestions.

The job affinity scoring server 1310 calculates the job affinity scores, as illustrated above with reference to FIGS. 7A-7B and 8-12. The job-to-group scoring server 1312 calculates the job-to-group scores (e.g., the company affinity score for the company-relationship group), as illustrated above with reference to FIGS. 713 and 8-12. The group affinity scoring server 1314 calculates the group affinity scores, as illustrated above with reference to FIGS. 7B and 8-12.

The job group coordinator server 1308 calculates the combined score for the scores identified above. The job group coordinator server 1308 further ranks the different groups in order to determine the priority of presentation of the groups in the user interface, and which groups will be presented or omitted. in addition, the job group coordinator server 1308 may determine in which group to present a job, if the job could be presented in two or more groups.

It is to be noted that the embodiments illustrated in FIG. 13 are examples and do not describe every possible embodiment. Other embodiments may utilize different servers or additional servers, combine the functionality of two or more servers into a single server, utilize a distributed server pool, and so forth. The embodiments illustrated in FIG. 13 should therefore not be interpreted to be exclusive or limiting, but rather illustrative.

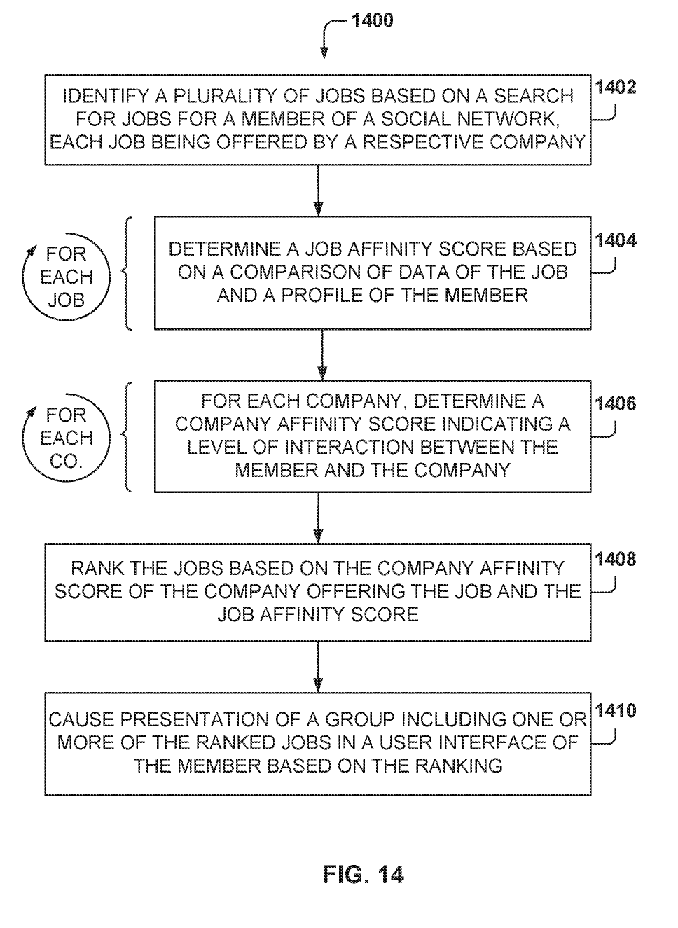

FIG. 14 is a flowchart of a method 1400, according to some example embodiments, for searching job postings for a member of a social network based on transitions of members in the social network from educational institutions to companies. While the various operations in this flowchart are presented and described sequentially, one of ordinary skill will appreciate that some or all of the operations may be executed in a different order, be combined or omitted, or be executed in parallel.

Operation 1402, is for identifying, by a server having one or more processors, a plurality of jobs based on a search for jobs for a member of the social network, with each job being offered by a respective company. From operation 1402, the method flows to operation 1404, where the server determines, for each job, a job affinity score based on a comparison of data of the job and a profile of the member.

From operation 1404, the method flows to operation 1406, where the server determines, for each company, a company affinity score indicating a level of interaction between the member and the company.

From operation 1406, the method flows to operation 1408, where the server ranks the jobs based on the company affinity score of the company offering the job and the job affinity score. From operation 1408, the method flows to operation 1410 for causing, by the server, presentation of a group including one or more of the ranked jobs in a user interface of the member based on the ranking.

In one example, determining the company affinity score is performed by a first machine-learning algorithm based on interactions between the member and the company, with the first machine-learning algorithm being trained utilizing data indicating activities of members of the social network, profile data of the members of the social network, and job data.

In another example, the company affinity score is calculated based on activities of the member related to the company, with the activities including one or more of views of company website, the member following the company and how long the member has been following the company, number of job searches performed by the member for jobs offered by the company, and number of views by the member when presented jobs offered by the company. In another example, the company affinity score is further based on a degree of interactions between the member and employees of the company and a number of connections in the social network between the member and employees of the company. In yet another example, the method as recited where the company affinity score is further based on a size of the company.

In one example, the method 1400 as recited, where ranking the jobs further includes ranking the jobs based on a weighted average of the company affinity score of the company offering the job and the job affinity score.

In another example, the method 1400 as recited further includes filtering jobs associated with companies having a company affinity score below a predetermined threshold, where the filtered jobs are not presented in the group within the user interface.

In one example, determining the job affinity score is performed by a second machine-learning program based on the data of the job and the profile of the member, with the second machine-learning program being trained utilizing data of job postings in the social network and data of members of the social network.

In another example, the user interface further presents additional groups, where the groups are sorted based on respective job affinity scores of jobs within each group, group affinity scores for each group, and job-to-group scores for each group.

in some examples, calculating a group affinity score for the member is based on interactions of the member related to job searches or job applications for a plurality of companies.

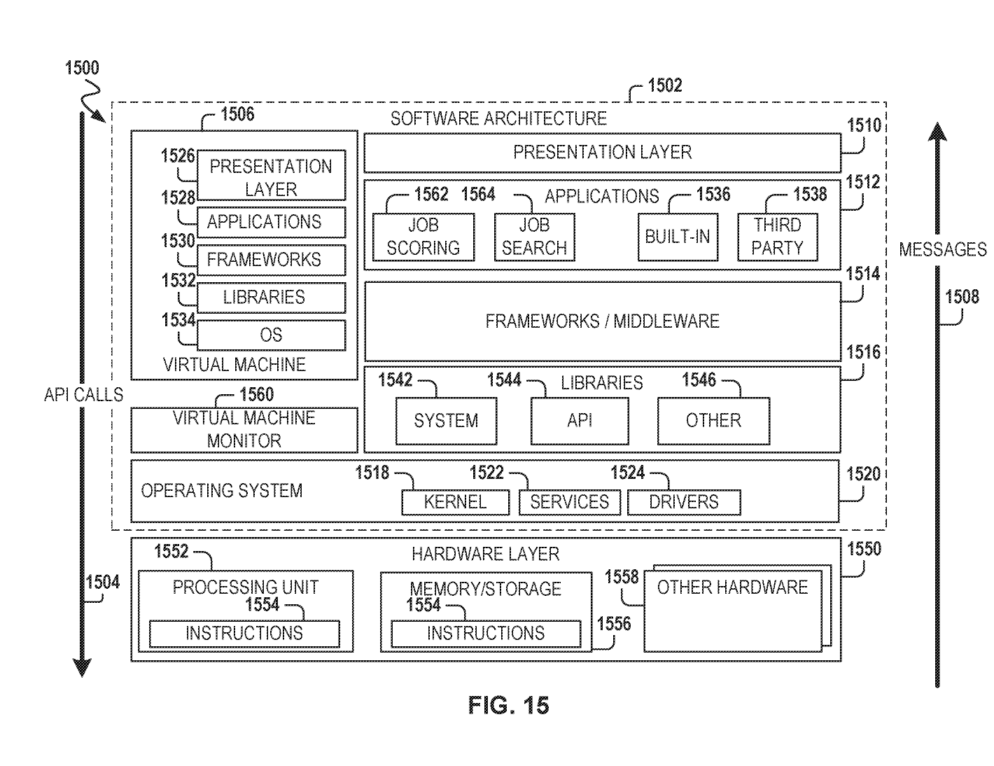

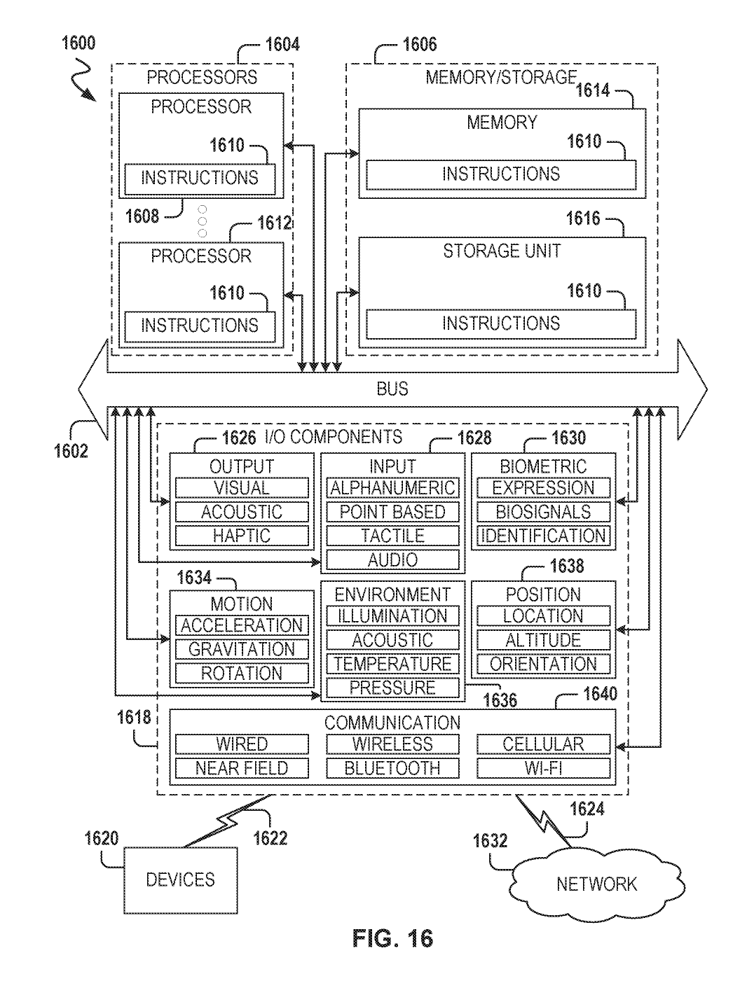

FIG. 15 is a block diagram 1500 illustrating a representative software architecture 1502, which may be used in conjunction with various hardware architectures herein described. FIG. 15 is merely a non-limiting example of a software architecture 1502, and it will be appreciated that many other architectures may be implemented to facilitate the functionality described herein. The software architecture 1502 may be executing on hardware such as a machine 1600 of FIG. 16 that includes, among other things, processors 1604, memory/storage 1606, and input/output (I/O) components 1618. A representative hardware layer 1550 is illustrated and can represent, for example, the machine 1600 of FIG. 16. The representative hardware layer 1550 comprises one or more processing units 1552 having associated executable instructions 1554. The executable instructions 1554 represent the executable instructions of the software architecture 1502, including implementation of the methods, modules, and so forth of FIGS. 1-6, 8, and 10-12. The hardware layer 1550 also includes memory and/or storage modules 1556, which also have the executable instructions 1554. The hardware layer 1550 may also comprise other hardware 1558, which represents any other hardware of the hardware layer 1550, such as the other hardware illustrated as part of the machine 1600.

In the example architecture of FIG. 15, the software architecture 1502 may be conceptualized as a stack of layers where each layer provides particular functionality. For example, the software architecture 1502 may include layers such as an operating system 1520, libraries 1516, frameworks/middleware 1514, applications 1512, and a presentation layer 1510. Operationally, the applications 1512 and/or other components within the layers may invoke API calls 1504 through the software stack and receive a response, returned values, and so forth illustrated as messages 1508 in response to the API calls 1504. The layers illustrated are representative in nature, and not all software architectures have all layers. For example, some mobile or special-purpose operating systems may not provide a frameworks/middleware layer 1514, while others may provide such a layer. Other software architectures may include additional or different layers.

The operating system 1520 may manage hardware resources and provide common services. The operating system 1520 may include, for example, a kernel 1518, services 1522, and drivers 1524. The kernel 1518 may act as an abstraction layer between the hardware and the other software layers. For example, the kernel 1518 may be responsible for memory management, processor management (e.g., scheduling), component management, networking, security settings, and so on. The services 1522 may provide other common services for the other software layers. The drivers 1524 may be responsible for controlling or interfacing with the underlying hardware. For instance, the drivers 1524 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1516 may provide a common infrastructure that may be utilized by the applications 1512 and/or other components and/or layers. The libraries 1516 typically provide functionality that allows other software modules to perform tasks in an easier fashion than by interfacing directly with the underlying operating system 1520 functionality (e.g., kernel 1518, services 1522, and/or drivers 1524). The libraries 1516 may include system libraries 1542 (e.g., C standard library) that may provide functions such as memory allocation functions, string manipulation functions, mathematic functions, and the like. In addition, the libraries 1516 may include API libraries 1544 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries(e.g., SQLite that may provide various relational database functions), web libraries (e.g., WebKit that may provide web browsing functionality), and the like. The libraries 1516 may also include a wide variety of other libraries 1546 to provide many other APIs to the applications 1512 and other software components/modules.

The frameworks 1514 (also sometimes referred to as middleware) may provide a higher-level common infrastructure that may be utilized by the applications 1512 and/or other software components/modules. For example, the frameworks 1514 may provide various graphical user interface (GUI) functions, high-level resource management, high-level location services, and so forth. The frameworks 1514 may provide a broad spectrum of other APIs that may be utilized by the applications 1512 and/or other software components/modules, some of which may be specific to a particular operating system or platform.

The applications 1512 include job-scoring applications 1562, job search/suggestions 1564, built-in applications 1536, and third-party applications 1538. The job-scoring applications 1562 comprise the job-scoring applications, as discussed above with reference to FIGS. 7A-7B. Examples of representative built-in applications 1536 may include, but are not limited to, a contacts application, a browser application, a book reader application, a location application, a media application, a messaging application, and/or a game application. The third-party applications 1538 may include any of the built-in applications 1536 as well as a broad assortment of other applications. In a specific example, the third-party application 1538 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1538 may invoke the API calls 1504 provided by the mobile operating system such as the operating system 1520 to facilitate functionality described herein.

The applications 1512 may utilize built-in operating system functions (e.g., kernel 1518, services 1522, and/or drivers 1524), libraries (e.g., system libraries 1542, API libraries 1544, and other libraries 1546), or frameworks/middleware 1514 to create user interfaces to interact with users of the system. Alternatively, or additionally, in some systems, interactions with a user may occur through a presentation layer, such as the presentation layer 1510. In these systems, the application/module “logic” can be separated from the aspects of the application/module that interact with a user.

Some software architectures utilize virtual machines. In the example of FIG. 15, this is illustrated by a virtual machine 1506. A virtual machine creates a software environment where applications/modules can execute as if they were executing on a hardware machine (such as the machine 1600 of FIG. 16, for example). The virtual machine 1506 is hosted by a host operating system (e.g., operating system 1520 in FIG. 15) and typically, although not always, has a virtual machine monitor 1560, which manages the operation of the virtual machine 1506 as well as the interface with the host operating system (e.g., operating system 1520). A software architecture executes within the virtual machine 1506, such as an operating system 1534, libraries 1532, frameworks/middleware 1530, applications 1528, and/or a presentation layer 1526. These layers of software architecture executing within the virtual machine 1506 can be the same as corresponding layers previously described or may be different.

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1610 (e.g., software, a program, an application, an applet, an app, or other executable code) for causing the machine 1600 to perform any one or more of the methodologies discussed herein may be executed. For example, the instructions 1610 may cause the machine 1600 to execute the flow diagrams of FIGS. 1142 and 14. Additionally, or alternatively, the instructions 1610 may implement the job-scoring programs and the machine-learning programs associated with them. The instructions 1610 transform the general, non-programmed machine 1600 into a particular machine 1600 programmed to carry out the described and illustrated functions in the manner described.

In alternative embodiments, the machine 1600 operates as a standalone device or may be coupled (e.g., networked) to other machines. in a networked deployment, the machine 1600 may operate in the capacity of a server machine or a client machine in a server-client network environment, or as a peer machine in a peer-to-peer (or distributed) network environment. The machine 1600 may. comprise, but not be limited to, a switch, a controller, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1610, sequentially or otherwise, that specify actions to be taken by the machine 1600. Further, while only a single machine 1600 is illustrated, the term “machine” shall also be taken to include a collection of machines 1600 that individually or jointly execute the instructions 1610 to perform any one or more of the methodologies discussed herein.

The machine 1600 may include processors 1604, memory/storage 1606, and 110 components 1618, which may be configured to communicate with each other such as via a bus 1602. In an example embodiment, the processors 1604 (e.g., a Central Processing Unit (CPU), a Reduced instruction Set Computing (RISC) processor, a Complex instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1608 and a processor 1612 that may execute the instructions 1610. The term “processor” is intended to include multi-core processors that may comprise two or more independent processors (sometimes referred to as “cores”) that may execute instructions contemporaneously. Although FIG. 16 shows multiple processors 1604, the machine 1600 may include a single processor with a single core, a single processor with multiple cores (e.g., a multi-core processor), multiple processors with a single core, multiple processors with multiples cores, or any combination thereof.

The memory/storage 1606 may include a memory 1614, such as a main memory, or other memory storage, and a storage unit 1616, both accessible to the processors 1604 such as via the bus 1602. The storage unit 1616 and memory 1614 store the instructions 1610 embodying any one or more of the methodologies or functions described herein. The instructions 1610 may also reside, completely or partially, within the memory 1614, within the storage unit 1616, within at least one of the processors 1604 (e.g., within the processor's cache memory), or any suitable combination thereof, dud ng execution thereof by the machine 1600. Accordingly, the memory 1614, the storage unit 1616, and the memory of the processors 1604 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media a centralized or distributed database, or associated caches and servers) able to store the instructions 1610. The term “machine-readable medium” shall also be taken to include any medium, or combination of multiple media, that is capable of storing instructions (e.g., instructions 1610) for execution by a machine (e.g., machine 1600), such that the instructions, when executed by one or more processors of the machine (e.g., processors 1604), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1618 may include a wide variety of components to receive input, provide output, produce output, transmit information, exchange information, capture measurements, and so on. The specific I/O components 1618 that are included in a particular machine will depend on the type of machine. For example, portable machines such as mobile phones will likely include a touch input device or other such input mechanisms, while a headless server machine will likely not include such a touch input device. It will be appreciated that the I/O components 1618 may include many other components that are not shown in FIG. 16. The I/O components 1618 are grouped according to functionality merely for simplifying the following discussion, and the grouping is in no way limiting. In various example embodiments, the I/O components 1618 may include output components 1626 and input components 1628. The output components 1626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1628 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1618 may include biometric components 1630, motion components 1634, environmental components 1636, or position components 1638 among a wide array of other components. For example, the biometric components 1630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1634 may include acceleration sensor components (e.g., accelerometer), gravitation sensor components, rotation sensor components (gyroscope), and so forth. The environmental components 1636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1618 may include communication components 1640 operable to couple the machine 1600 to a network 1632 or devices 1620 via a coupling 1624 and a coupling 1622, respectively. For example, the communication components 1640 may include a network interface component or other suitable device to interface with the network 1632. In further examples, the communication components 1640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1620 may be another machine or any of a wide variety of peripheral devices (e.g., a peripheral device coupled via a USB).

Moreover, the communication components 1640 may detect identifiers or include components operable to detect identifiers. For example, the communication components 1640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1640, such as location via Internet Protocol (IP) geo-location, location via Wi-Fi® signal triangulation, location via detecting an NEC beacon signal that may indicate a particular location, and so forth.

In various example embodiments, one or more portions of the network 1632 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1632 or a portion of the network 1632 may include a wireless or cellular network and the coupling 1624 may be a Code Division Multiple Access (CDMA) connection, a Global System for Mobile communications (GSM) connection, or another type of cellular or wireless coupling. In this example, the coupling 1624 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1610 may be transmitted or received over the network 1632 using a transmission medium via a network interface device (e.g., a network interface component included in the communication components 1640) and utilizing any one of a number of well-known transfer protocols (e.g., hypertext transfer protocol (HTTP)). Similarly, the instructions 1610 may be transmitted or received using a transmission medium via the coupling 1622 (e.g., a peer-to-peer coupling) to the devices 1620. The term “transmission medium” shall be taken to include any intangible medium that is capable of storing, encoding, or carrying the instructions 1610 for execution by the machine 1600, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may he implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to he regarded in an illustrative rather than a restrictive sense.

What is claimed is:

1. A method comprising:
identifying, by one or more processors, a plurality of jobs based on a search for jobs for a member of a social network, each job being offered by a respective company;
for each job, determining, by the one or more processors, a job affinity score based on a comparison of data of the job and a profile of the member;
for each company, determining, by the one or more processors, a company affinity score indicating a level of interaction between the member and the company;
ranking, by the one or more processors, the jobs based on the company affinity score of the company offering the job and the job affinity score; and
causing, by the one or more processors, presentation of a group including one or more of the ranked jobs in a user interface of the member based on the ranking.

2. The method as recited in claim 1, wherein determining the company affinity score is performed by a first machine-learning algorithm based on interactions between the member and the company, the first machine-learning algorithm being trained utilizing data indicating activities of members of the social network, profile data of the members of the social network, and job data.

3. The method as recited in claim 1, wherein the company affinity score is calculated based on activities of the member related to the company, the activities including one or more of views of company website, the member following the company and how long the member is following the company, number of job searches performed by the member for jobs offered by the company, and number of views by the member when presented jobs offered by the company.

4. The method as recited in claim 3, wherein the company affinity score is further based on a degree of interaction between the member and employees of the company and a number of connections in the social network between the member and employees of the company.

5. The method as recited in claim 4, wherein the company affinity score is further based on a size of the company.

6. The method as recited in claim 1, wherein ranking the jobs further comprises:
ranking the jobs based on a weighted average of the company affinity score of the company offering the job and the job affinity score.

7. The method as recited in claim 1, further comprising:
filtering jobs associated with companies having a company affinity score below a predetermined threshold, wherein the filtered jobs are not presented in the group within the user interface.

8. The method as recited in claim 1, wherein determining the job affinity score is performed by a second machine-learning program based on the data of the job and the profile of the member, the second machine-learning program being trained utilizing data of job postings in the social network and data of members of the social network,

9. The method as recited in claim 1, wherein the user interface further presents additional groups, wherein the groups are sorted based on respective job affinity scores of jobs within each group, group affinity scores for each group, and job-to-group scores for each group.

10. The method as recited in claim 1, further comprising:
calculating a group affinity score for the member based on interactions of the member related to job searches or job applications for a plurality of companies.

11. A system comprising:
a memory comprising instructions; and
one or more computer processors, wherein the instructions, when executed by the one or more computer processors, cause the one or more computer processors to perform operations comprising:
identifying a plurality of jobs based on a search for jobs for a member of a social network, each job being offered by a respective company;
for each job, determining a job affinity score based on a comparison of data of the job and a profile of the member;
for each company, determining a company affinity score indicating a level of interaction between the member and the company;
ranking the jobs based on the company affinity score of the company offering the job and the job affinity score; and
causing presentation of a group including one or more of the ranked jobs in a user interface of the member based on the ranking.

12. The system as recited in claim 11, wherein determining the company affinity score is performed by a first machine-learning algorithm based on interactions between the member and the company, the first machine-learning algorithm being trained utilizing data indicating activities of members of the social network, profile data of the members of the social network, and job data.

13. The system as recited in claim 11, wherein the company affinity score is calculated based on activities of the member related to the company, the activities including one or more of views of company website, the member following the company and how long the member is following the company, number of job searches performed by the member for jobs offered by the company, and number of views by the member when presented jobs offered by the company.

14. The system as recited in claim 13, wherein the company affinity score is further based on a degree of interaction between the member and employees of the company and a number of connections in the social network between the member and employees of the company.

15. The system as recited in claim 4, herein the company affinity score is further based on a size of the company.

16. A non-transitory machine-readable storage medium including instructions that, when executed by a machine, cause the machine to perform operations comprising:
identifying a plurality of jobs based on a search for jobs for a member of a social network, each job being offered by a respective company;
for each job, determining a job affinity score based on a comparison of data of the job and a profile of the member;
for each company, determining a company affinity score indicating a level of interaction between the member and the company;
ranking the jobs based on the company affinity score of the company offering the job and the job affinity score; and
causing presentation of a group including one or more of the ranked jobs in a user interface of the member based on the ranking.

17. The machine-readable storage medium as recited in claim 16, wherein determining the company affinity score is performed by a first machine-learning algorithm based on interactions between the member and the company, the first machine-learning algorithm being trained utilizing data indicating activities of members of the social network, profile data of the members of the social network, and job data.

18. The machine-readable storage medium as recited in claim 16, wherein the company affinity score is calculated based on activities of the member related to the company, the activities including one or more of views of company website, the member following the company and howl long the member is following the company, number of job searches performed by the member for jobs offered by the company, and number of views by the member when presented jobs offered by the company.

19. The machine-readable storage medium as recited in claim 18, wherein the company affinity score is further based on a degree of interaction between the member and employees of the company and a number of connections in the social network between the member and employees of the company.

20. The machine-readable storage medium as recited in claim 19, wherein the company affinity score is further based on a size of the company.
